(19) United States
(12) Patent Application Publication
(10) Pub. No.: US 2005/0069466 A1
(43) Pub. Date: Mar. 31, 2005

(54) Fluidizing reactor and method for treatment of fluids

(75) Inventor: Neil Helwig, Mason, OH (US)

Correspondence Address: FOLEY HOAG, LLP;PATENT GROUP, WORLD TRADE CENTER WEST, 155 SEAPORT BLVD, BOSTON, MA, 02110, US

(73) Assignee: Marine Biotech Incorporated, Beverly, MA (US)

(21) Appl. No.: 10/912,871

(22) Filed: Aug. 6, 2004

Related U.S. Application Data
(62) Division of application No. 10/281,636, filed on Oct. 28, 2002, now abandoned.
Application No. 10/281,636 is a continuation of application No. 09/595,704, filed on Jun. 16, 2000, now abandoned.
(60) Provisional application No. 60/139,437, filed on Jun. 16, 1999.

(51) Int. Cl. B01J 8/18

(52) U.S. Cl. 422/139

(57) ABSTRACT

A fluidizing reactor for treatment of fluid is provided. The fluidizing reactor includes an elongated column having an interior chamber extending between a first end and a second end of the column. The reactor also includes a plenum situated circumferentially about the second end of the column, and an inlet tangentially positioned relative to plenum, so as to introduce fluid to be treated into the plenum. The tangential position of the inlet imparts to the fluid a uniform cyclonic flow pattern circumferentially about the column. The reactor further includes an annulus about the second end of the column to provide an opening through which fluid from the plenum may enter into the interior chamber. Fluid flowing through the annulus is uniformly distributed into the interior chamber and maintains a cyclonic flow pattern. A fluid treatment material may be provided to treat the fluid flowing into the interior chamber.

### CROSS-REFERENCE TO RELATED APPLICATIONS

The present application is a divisional of commonly assigned copending U.S. patent application Ser. No. 10/281,636, which was filed on Oct. 28, 2002, by Neil E. Helwig for a Fluidizing Reactor and Method for Treatment of Fluids and is hereby incorporated by reference, and which in turn claimed the benefit of U.S. Provisional Patent Application Ser. No. 60/139,437 filed Jun. 16, 1999, which is hereby incorporated by reference.

### BACKGROUND OF THE INVENTION

1. Field of the Invention

The present invention relates to fluidizing reactors, and more particularly, to granular bed reactors designed to treat fluids with hydraulic efficiency. The present invention also relates to methods for treatment of fluids.

2. Background Information

While Fluidized Bed Reactors, and in particular, Fluidized Sand Beds (FSBs) have played an important role in the evolution of Recirculation Aquaculture Systems (RAS), there have been complications associated with the use of FSBs. Conventional FSBs have been used most often for biological filtration in RAS, for instance, to treat culture water used to raise aquatic organisms. The concept behind FSBs is to expose the culture water to a very large surface area in a small volumetric space during the treatment process. For example, having a one cubic meter of bed of sand for FSBs can provide up to about 25,000 square meters of available surface area, depending on the size of the sand granules. The available surface area from the sand granules provides a habitat for specialized bacteria that, for instance, can oxidize toxic ammonia excreted in the biomass in the culture water, and convert it into non-toxic substances. The amount of ammonia that can be oxidized is generally proportional to the amount of surface area available for the bacteria to populate.

FSBs exposes the available surface area provided by the granules by “fluidizing” the sand bed within a column. In particular, fluid to be treated may be introduced through the bottom of the sand bed at a rate which is sufficient to lift and suspend the granules as the fluid travel through the sand bed. The once packed or “static” sand bed now becomes a viscous, fluid substance with a clearly defined volume within the flowing column of fluid. As the sand bed becomes fluidized, the granules of sand are separated from one another with much of the surface area on each granule exposed. A static sand bed, on the another hand, is packed, so as to cover most of the surface area on each granule. In addition to having an increased the amount of surface area, the fluidized sand bed generally has a volume greater than that of the static sand bed.

Despite its simplicity, the application of FSBs can often be frustrating and complicated. Conventional FSBs, such as that shown in FIGS. 1A-B, utilize an internal manifold system with extensive plumbing to direct fluid to be treated through the manifold. In particular, the manifold is usually placed beneath the sand bed, at the bottom of the reactor, with fluid feeding pipes extending from the top of the reactor down to the manifold. Upon feeding of untreated fluid to the manifold for fluidizing the sand bed, there is significant pressure loss due to the piping design, as well as the outlet design on the manifold. In addition, fluid velocity through the outlets on the manifold can be high, as the outlets have smaller diameters than the diameter of the manifold, and can be extremely abrasive. The abrasive characteristics of fluid at high velocities in the presence of sand has been attributed to catastrophic destruction of FSB reactors and the concrete floors upon which they are built. An increase in fluid velocity can also cause uneven distribution of fluid into the sand bed, which can lead to the generation of zones of turbulence in the sand bed. The presence of turbulence in the sand bed can decrease hydraulic efficiency, as well as performance of the sand bed by creating an inhospitable environment for the bacteria on the sand granules. In addition, as the manifold system is used over time, particulates in the untreated fluid can clog the outlets in the manifold. Moreover, the placement of the manifold in the sand bed can further lead to clogging of the outlets with sand upon shut down. To clean out the manifold, additional complex piping is usually necessary for accessing the manifold from the top of the reactor. The addition of expensive piping and the need for frequent cleaning of the manifold can add to the cost of operating the reactor.

Accordingly, it is desirable to provide a fluidizing reactor which can uniformly introduce and distribute fluid through the sand bed, and adequately reduce the velocity of the fluid therethrough, so as to increase hydraulic efficiency of the reactor, decrease operating cost, and generate a more hospitable environment for reactions to be carried out.

### SUMMARY OF THE INVENTION

The present invention provides a fluidizing reactor for treatment of fluid. The fluidizing reactor, in accordance with one embodiment, includes a column having an interior chamber extending between a first end and a second end of the column. The fluidizing reactor also includes a plenum situated circumferentially about the second end of the column. The plenum, in one embodiment, may be situated circumferentially about an outer surface of the column. Alternatively, the plenum may be configured to be positioned circumferentially about the interior chamber of the column. The configuration of the plenum can induce a substantially uniform flow pattern, as fluid introduced into the plenum is permitted to flow in a cyclonic path circumferentially about the column. To introduce fluid into the plenum, the fluidizing reactor may be provided with an inlet in communication with the plenum. The inlet, in one embodiment, may be positioned tangentially to the plenum, so as to impart a cyclonic flow to the fluid introduced therethrough. The fluidizing reactor may further include an annulus positioned, in one embodiment, between the second end of the column and a lower end of the plenum, and which extends circumferentially about the column. The annulus provides an opening through which fluid may exit the plenum and flows upwardly into the interior chamber of the column. In one embodiment of the invention, a flow director may be provided about the annulus, so that fluid exiting through the annulus may be directed toward the center of the interior chamber. Such a flow director may permit the flow of fluid into the interior chamber to approximate a “plug-flow” pattern. In other words, at any cross-sectional portion through the interior chamber, the rate of flow moves substantially uniformly upward along the column. The reactor may also include a deflector concentrically aligned within the interior chamber and adjacent the annulus. The presence of the deflector improves the flow of fluid from the annulus upwardly and toward a center of the interior chamber. The fluidizing reactor may further include a bed of treating material for treating the fluid introduced into the reactor. The material can be any granular material that is substantially denser than the fluid within the interior chamber. The reactor may also be provided with an outlet in communication with the interior chamber of the column through which fluid moving upwardly from within the interior chamber may be removed therefrom.

In accordance with another embodiment of the present invention, a system for treatment of fluid is provided. The system may include, in an embodiment, a source of fluid to be treated and a first pathway in fluid communication with the source. The first pathway provides a route along which fluid can be directed into a fluidizing reactor through an inlet of the reactor. Fluid moving from the source along the first pathway may, in one embodiment, be facilitated by gravity. Alternatively, a pressurizing mechanism may be employed to facilitate the flow of fluid flow along the first pathway. The system further includes a second pathway for directing fluid from within the reactor through an outlet. In connection with the fluid being removed from within the reactor, a second pressurizing mechanism may be provided for pressurizing fluid within the reactor, so as to facilitate removal of fluid through the outlet. The system may further include a receptor for receiving fluid from the second pathway. In one embodiment, wherein for instance, the system is a closed system, the source of fluid to be treated may also act as the receptor of fluid from the second pathway. In an alternate embodiment, wherein the system may include additional fluid treatment devices, the receptor and the source may be other treatment devices.

A method for treatment of fluid is also provided in accordance with an embodiment of the present invention. The method involves generating a flow direction for the fluid to be treated, which flow direction approximates a cyclonic pattern. Subsequently, the fluid may be permitted to follow a spiral path downward, while the cyclonic pattern is maintained. Thereafter, the flow direction may be directed upwardly and centrally through the cyclonic pattern. In one embodiment, the upward flow follows a plug-flow pattern, during which a treatment material may be introduced into the flow to treat the fluid.

In another embodiment, fluid to be treated may be introduced from a source to into an interior chamber of a fluidizing reactor at an upper portion of the interior chamber. The fluid may thereafter be subjected to a downward flow through a bed of granular treatment material positioned at a bottom portion of the interior chamber. The fluid may next be directed through an annulus and into a plenum situated circumferentially about a bottom end of the reactor. The fluid may then be permitted to flow upward within the plenum and removed from the plenum through an outlet.

### BRIEF DESCRIPTION OF THE DRAWINGS

FIGS. 1A-B illustrate a longitudinal and top view of a prior art fluidizing reactor.

FIG. 2A illustrates a longitudinal view of a fluidizing reactor in accordance with one embodiment of the present invention.

FIG. 2B illustrates a top view of the fluidizing reactor shown in FIG. 1A.

FIG. 3 illustrates a longitudinal view of a fluidizing reactor in accordance with another embodiment of the present invention.

FIGS. 4-6 illustrate various systems of the present invention for the treatment of fluid.

### DETAILED DESCRIPTION OF AN ILLUSTRATIVE EMBODIMENT

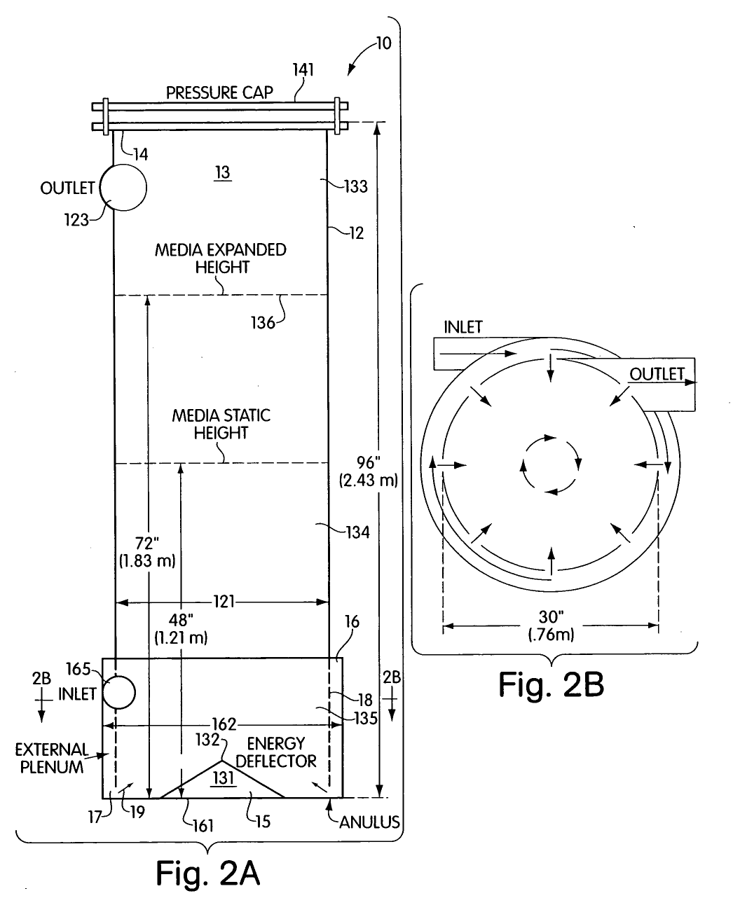

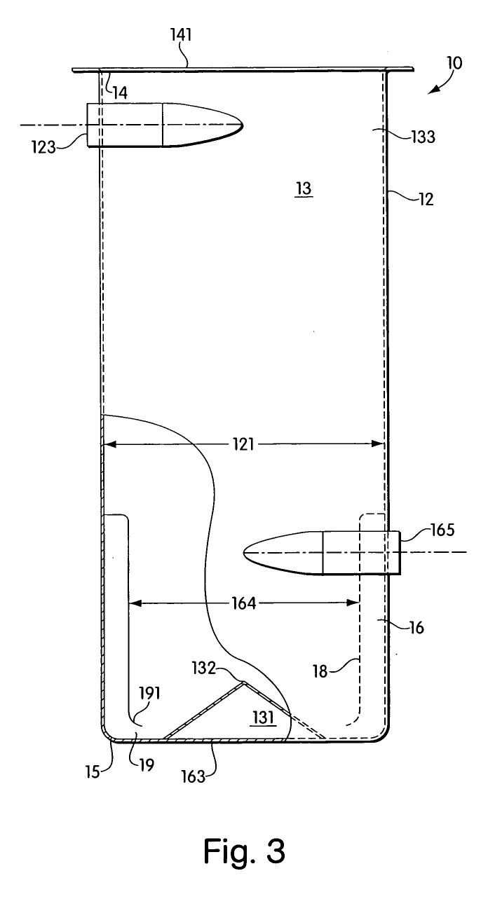

Referring now to the drawings, there are shown in FIGS. 2A-B a fluidizing reactor 10, in accordance with one embodiment of the present invention, for treatment of fluid. The fluidizing reactor 10 includes a column 12, which column may be provided with an interior chamber 13 extending between a first end 14 and a second end 15 of the column 12. The column 12, in accordance with one embodiment, may be substantially cylindrical in shape along its entire length. Although shown to be substantially cylindrical, it should be appreciated that the column may be provided with any geometrical shape along its length, so long as the shape permits the column to maintain fluid to be treated therein. The fluidizing reactor 10 also includes a plenum 16 for receiving fluid introduced into the fluidizing reactor 10. The plenum 16, in one embodiment, may be situated circumferentially about the second end 14 of the column 12, and includes a lower end 17. As shown in FIGS. 2A-B, the plenum 16 may be situated circumferentially about an outer surface 18 of the column 12. In the configuration shown in FIG. 2A, it should be appreciated that the plenum 16 may be provided with a surface 161 extending across the lower end 17 of the plenum 16, and may be provided with a diameter 162 which is relatively larger than a diameter 121 of the column 12. In an alternative embodiment, the plenum 16 may be situated circumferentially about the interior chamber 13, as illustrated in FIG. 3. In this embodiment, the plenum 16 may be provided with a surface 163 which extends across the second end 15 of the column 12. The plenum 16, in this embodiment, includes a diameter 164 which is smaller relative to the diameter 121 of column 12. The plenum 16, whether it is positioned along the outer surface 18 (as shown in FIGS. 2A-B) or along the interior chamber 13 (as shown in FIG. 3), may be configured to induce a substantially uniform flow pattern to the fluid introduced into the plenum. In particular, as fluid is introduced into the plenum 16, the fluid is directed along the plenum wall, causing the fluid to flow at a substantially uniform velocity circumferentially about the column 12. It should be noted that the plenum 16 does not necessarily have to have a constant diameter from its top to its lower end 17. However, its configuration should permit the plenum 16 to maintain a cyclonic flow pattern of substantially uniform velocity.

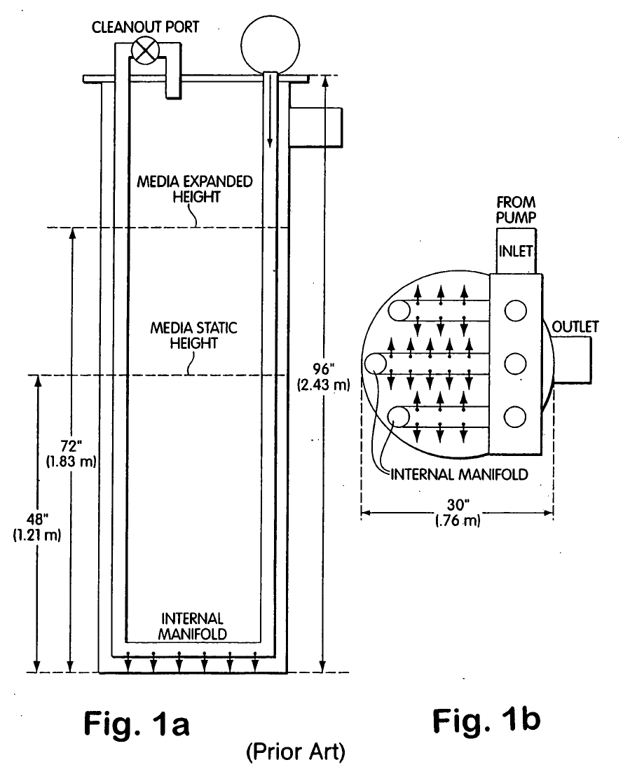

To introduce fluid to be treated into the plenum 16, an inlet 165 is provided. The inlet 165, in one embodiment, may be positioned in tangential communication with the plenum 16. The tangential position of the inlet 165 relative to the plenum 16 permits the fluid entering into the plenum 16 to flow along the wall of the plenum, resulting in a cyclonic flow circumferentially about the column 12. The fluidizing reactor 10 may further include an annulus 19 situated about the second end 15 of the column 12. As shown in FIGS. 2A and 3, the annulus may be positioned between the second end 15 of the column 12 and the lower end 17 of the plenum 16, so as to provide an opening through which fluid may flow from the plenum 16 upwardly into the interior chamber 13. The annulus 19, in a preferred embodiment, is provided with a dimension sufficient to allow fluid to exit therethrough at a velocity relatively higher than the velocity of fluid circulating within the plenum 16. The velocity of the fluid exiting the annulus 19, in one embodiment, may be within a range of up to approximately 25.0 ft/sec². In this manner, fluid flowing through the annulus 19 may be uniformly distributed into the interior chamber 13. Despite the higher velocity through the annulus 19, fluid exiting through the annulus 19 is substantially less than the velocity of fluid moving through the holes of a conventional manifold, such as that shown in FIG. 1. In particular, the reduction in velocity over the conventional manifold may be from about 85% to 95% less. The ability of the annulus 19 to reduce fluid velocity over conventional reactors, while providing uniform distribution of the fluid with substantially little or no change between the velocity of fluid within the plenum and the velocity of the fluid exiting the plenum, can lead to increase hydraulic efficiency and significant energy savings. Furthermore, the reduction in the velocity of the fluid can decrease the likelihood of damage to the reactor 10 by fast moving fluid.

A flow director 191, as shown in FIG. 3, may be provided along the annulus 19 to facilitate the flow of fluid from the plenum 16 into the interior chamber 13. In one embodiment of the invention, the flow director 191 may be placed along the entire circumference of the annulus 19 to direct the flow of fluid toward a central area of the interior chamber 13 through which axis X extends. The flow director 191 may also help to facilitate the transition of fluid flow from the plenum 16 into the interior chamber 13 by permitting the fluid to follow a relatively laminar flow pattern along the director 191 into the interior chamber 13. By allowing the fluid flow to follow a relatively laminar pathway, the amount of turbulent flow into the interior chamber 13 may be reduced. With a reduction in turbulent flow, fluid entering the interior chamber 13 may approximate a plug-flow pattern as it travels upward along the column 12. In other words, along any cross-sectional portion across the interior chamber 13, the rate of flow moves substantially uniformly upward along the column 12. It should be appreciated that although the flow across the annulus may be relatively laminar, the direction of the fluid flow, as illustrated in FIG. 2B, may still follow a cyclonic pattern upward along the interior chamber 13.

To further enhance the upward flow of fluid once across the annulus 19 and toward the axis X, the fluidizing reactor 10 may be provided with a deflector 131. The deflector 131, as shown in FIGS. 2A and 3 may be positioned within the interior chamber 13 and adjacent the annulus 19, such that the deflector 131 is in axial alignment with the column 12. The deflector 131 may include a slope rising away from the annulus 19 toward the axis X, and terminating in apex 132. In accordance with an embodiment of the present invention, the deflector 131 may be include a slope rising at about a 35° angle and may include a diameter which is approximately 70% to 75% of the diameter 121 of the column 12. The deflector 131 may be conical in shape; however, it may have other geometric shapes, for instance, square, pentagonal, or hexagonal, so long as its shape provides the deflector 131 with the ability to deflect fluid flow from the annulus 19 upwardly and toward the axis X.

As fluid flows upwardly along the interior chamber 13, the fluid within upper portion 133 of the chamber 13 may be pushed through an outlet 123. The presence of the outlet 123 permits the level of fluid within interior chamber 13 to be maintained below a point of overspill. Should it be desirable to direct the flow of fluid exiting the outlet 123 to a level higher than the level of the outlet 123, the fluidizing reactor 10 may be provided with an enclosure 141 across the first end 14 of the column 12. The placement of the enclosure 141 across the first end 14 acts to pressurize the fluid within the interior chamber 13. As a result, fluid exiting the outlet 123 can be forced to a level higher than that of the outlet 123, for instance, into a receptor. To ensure its secure engagement to the first end 14, the enclosure 141 may be provided with any securing mechanism available in the art, for example, screws and bolts, complementary screw threads between the enclosure and the column, or bonding substances.

As the fluidizing reactor 10 of the present invention may be used in various industries for various treatment applications, for example, chemical or biological, toxic or non-toxic, the fluidizing reactor is preferably made from a material which is compatible with the fluid being treated and which is substantially corrosion-resistant. Moreover, as the fluidizing reactor 10 must withstand large volume of fluid flow, the material used in the construction of the reactor 10 must be sufficiently strong to provide support along and throughout the reactor 10. Accordingly, materials which may be used include, but are not limited to metal, molded plastic, and thermoset, including thermoplastics and fiberglass. In an embodiment wherein fiberglass material is used, the fiberglass material may include approximately 40% to 75% commercially available FDA approved resin (Fib-Chem, Monessen, Pa.), and approximately 25% to 60% glass fibers. A small amount (e.g., about 0.5% to 2%) of a catalyst, such as methyl ethyl ketone peroxide (MEKP) (Fib-Chem, Monessen, Pa.) may be used to cure the FDA approved resin.

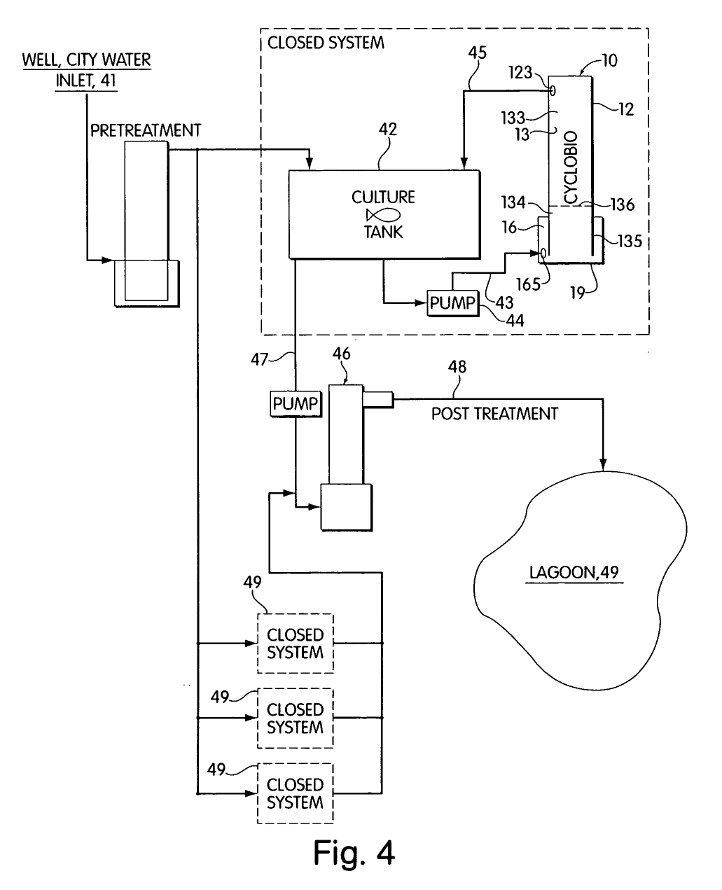

Referring now to FIG. 4, the fluidizing reactor 10, in accordance with an embodiment of the present invention, may be used within a system 40 for the treatment of biological fluid, for instance, in an aerobic nitrification process or an anaerobic denitrification process. As shown in FIG. 4, the fluidizing reactor 10 receives fluid to be treated from a source 41, such as a well, or source 42, such as an aquaculture tank. For the ease of discussion, the system 40 discussed herein after will be in connection with a closed loop system. However, it should be understood that the fluidizing reactor 10 may be part of an open system or a system wherein several fluidizing reactors 10 may be used.

Still looking at FIG. 4, fluid from the source 42 may be directed to the fluidizing reactor 10 along a pathway 43. Fluid from the pathway 43 may next be introduced into the reactor 10 through the inlet 165. Fluid moving along the pathway 43 to the inlet 165, in one embodiment, may be facilitated by gravity if the source 42 and the pathway 43 are positioned generally at a level higher than the level of the inlet 165. Alternatively, a pressurizing mechanism 44, such as a positive pressure pump, may be employed to facilitate the flow of fluid along the pathway 43. As the fluid is introduced through the inlet 165, the tangential placement of the inlet 165 relative to the plenum 16 causes the fluid to flow along the wall of the plenum 16 circumferentially about the column 12, thereby imparting a cyclonic flow within the plenum 16. The cyclonic flow within plenum 16 continues downward toward the annulus 19, and causes the fluid to be uniformly distributed through the annulus 19 and upward into the interior chamber 13 of column 12.

In the biological treatment of fluid, such as aquaculture fluid, the fluidizing reactor 10 may be provided with a bed of treatment material 134 at a bottom portion 135 of the interior chamber 13. The treatment material 134, in one embodiment, can be a granular medium having a higher density relative to that of the fluid to be treated and its contents. For instance, the treatment material 134 may be sand. Of course, other treatment material 134 may be used, so long as the material provides sufficient surface area for use as a habitat by, for example, specialized microorganisms (e.g., bacteria) to grow thereon, and to treat the fluid flowing through the material. For instance, the bacteria may oxidize toxic ammonia excreted in the biomass in the fluid, and convert it into non-toxic substances. It should be appreciated that the type of microorganism permitted to populate the surface area of each granule in the bed of treatment material will generally depend on the nutrient level or content of the fluid to be treated, and will generally determine the type of biological treatment process to be carried out.

As fluid moves across the annulus 19, in one embodiment, the fluid is distributed uniformly and upwardly by the cyclonic pattern, through the granular treatment medium 134, and toward the center of the interior chamber 13, while following a generally plug-flow pattern, so as to fluidize the bed of treatment medium 134. In order to fluidize the bed of treatment medium 134, the velocity at which the fluid to be treated should be introduced through the bottom of the treatment medium 134 is preferrably one which is sufficient to cause a homogenous expansion of the bed of treatment medium 134 with minimal turbulence along its upper surface 136. In other words, the velocity of the flow should be such that the fluid is capable of lifting and suspending the granules of the bed within the interior chamber 13 to increase, by exposure, the amount of surface area of the bed, for the fluid to be treated as it travels therethrough. As illustrated in FIG. 2A, the bed of treatment material 134, once fluidized, becomes a viscous, fluid bed with a clearly defined volume within the interior chamber 13. This clearly defined volume is generally greater than that of a static bed of treatment material. Accordingly, by employing a uniform cyclonic flow pattern, as illustrated in FIG. 2B, the bed of granular treatment medium 134 can be homogenously fluidized with little or no “dead” spots within the bed, wherein the treatment material 134 remains static and compact. This, as it will be appreciated, can contribute to the provision of a more hospitable environment within which the microorganisms may flourish, and can lead to an increase in, for instance, the nitrification or denitrification (depending on the treatment) rate per unit volume of reactor space.

Once the fluid, now treated, has reached the upper portion 133 of the interior chamber 13, the treated fluid may get pushed through the outlet 123 by fluid flow upward from the bottom portion 135 of the interior chamber 13. In connection with the removal of the treated fluid from within the interior chamber 13, a pressuring mechanism (not shown) may be provided for pressurizing the fluid within the chamber 13, so as to facilitate the removal of the treated fluid. In one embodiment, the pressuring mechanism may be a lid 141 positioned across the top end 14 of the column 12. Alternatively, the pressurizing mechanism may be a positive pressure pump, or may include both a lid and a pump. As the treated fluid leaves through the outlet 123, it travels along a second pathway 45; and, because the system 40 utilized is discussed in the context of a closed system, the fluid gets deposited back into the source 42. Such a closed system utilizing a fluidizing reactor 10 with a bed of treatment medium 134 may have large scale utility, for example, in the fish farming industry, for nitrification or denitrification of the fluid used to hold the fish. The closed system may also be used for recirculating water used in a pet fish tank or fish pond. Of course, the fluidizing reactor 10 must be scaled accordingly for the different applications. The system 40 described herein may also be used for various chemical treatments, for instance, for ion exchange to control the pH level of the fluid. In such a treatment, the treatment medium 134 may need to be modified from that used in the biological treatment to include retention of compounds within the bed which can facilitate ion exchange.

In an alternate embodiment, the system 40 may operate as an open system. Still referring to FIG. 4, the open system may include a source 42 within which fluid to be treated is maintained. Fluid from the source 42 may be directed to the fluidizing reactor 46 by way of pathway 47. However, after the fluid leaves the reactor 46 along pathway 48, unlike the closed system above, the open system described herein does not deposit the treated fluid back into the source 42. Rather, the treated fluid gets deposited into a receptor 49, such as a holding tank or a pond, that is spatially positioned away from the source 42. The open system may be useful in replenishing natural bodies of water with treated fluid which previously may have been contaminated with foreign particulates.

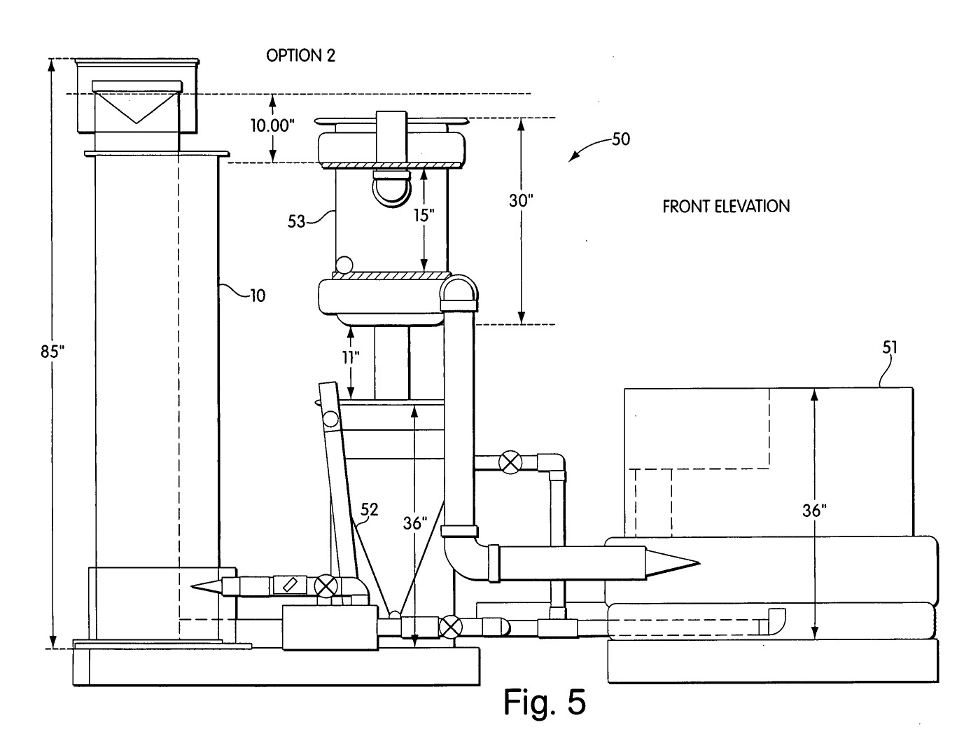

In addition to being used independently, the fluidizing reactor 10 of the present invention may be part of a system which includes multiple fluidizing reactors 10, 46 and 47, such as that shown in FIG. 4. In the system 40 shown in FIG. 4, a fluidizing reactor 47 may be provided to treat water received from the city well 41. The treated water may subsequently be fed along pathway 48 to, for instance, culture tank 42 for maintaining fish. As discussed above, this portion of the system 40 may include fluidizing reactor 10 as part of a closed loop system. Treated water from fluidizing reactor 47 may also be diverted to other closed loop systems 49. The closed loop systems 47 and 49 may be configured to divert some of the fluid from the source/receptor, such as culture tank 42, to fluidizing reactor 46, which reactor is part of an open loop in system 40, for post treatment prior to returning the treated water to a natural body of water, such as lagoon 49. The configuration provided in FIG. 4 is but one possible design for system 40. However, it should be understood that other configurations and/or modifications of the system 40 utilizing multiple fluidizing reactors may be employed to meet specific application needs. Moreover, the fluidizing reactor 10, as shown in FIG. 5, may be utilized, in accordance with one embodiment, as part of system 50, wherein fluidizing reactor 10 is in fluid communication with other fluid treatment devices, for example, a device 51 or 52 to permit settling of solids from liquid, a device 52 for separating solids from liquid, a device 53 for removing carbon dioxide (CO₂), and a device to permit removal of solids from liquid.

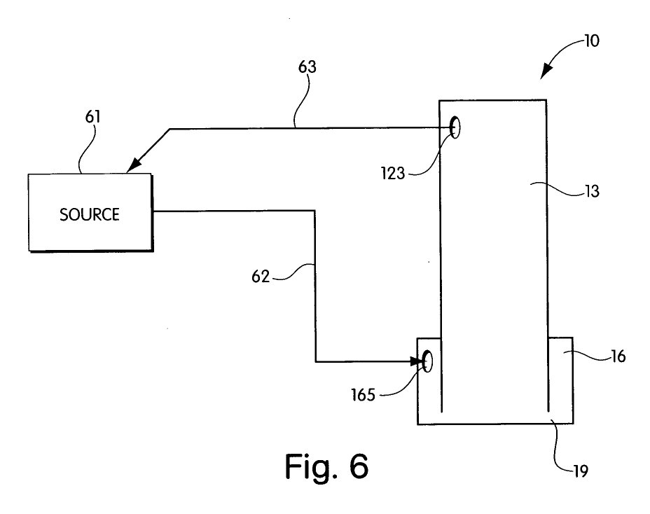

In accordance with another embodiment of the present invention, the fluidizing reactor 10 may be employed as a reactor chamber for the mixing and blending of various agents, for example, liquid with liquid, or liquid with solid. When utilized as a reactor chamber, the fluidizing reactor 10 may be used as a continuous process reactor vessel or a batch mixing reactor vessel. In the embodiment wherein the fluidizing reactor 10 is employed as a continuous process reactor vessel, the reactor 10 is configured to be part of a closed recirculating system 60, as illustrated in FIG. 6. The system 60 may include a source 61 containing various agents to be treated. The system may be provided with a number of sources, each containing an agents to be treated, if so desired.

As shown in FIG. 6, the agents contained within the source 61 may be metered and directed into the plenum 16 of the reactor 10 through the inlet 165 by way of pathway 62. Once within the plenum 16, the agents are subject to a cyclonic flow pattern, after which they are introduced into the interior chamber 13 of the reactor 10 through the annulus 19. When utilized as a mixing and blending vessel, the reactor 10 does not include a bed of treatment medium. Instead the agents are permitted to proceed along the cyclonic flow pattern within the interior chamber 13 for continual mixing and blending until the level within the interior chamber 13 reaches that of the outlet 123. Thereafter, the mixed product is permitted to exit through the outlet 123, where subsequently it may be redirected back into the source 61 along pathway 63 for additional mixing and blending if necessary. Once the desired mixing condition has been achieved, the process is stop and the mixed product removed from the reactor 10.

In the embodiment wherein the fluidizing reactor 10 is employed as a batch-mixing reactor vessel, the pathway 63 of the system 60 may be modified to lead the mixed product away from the reactor 10 into a receptor (not shown) different from the source 61. By collecting the mixed product in a different receptor, the mixed product in the batch-mixing process is not subject to remixing.

The system 60, which utilizes the fluidizing reactor 10 as a mixing and blending vessel absent a bed of treatment medium, may have many different applications. Some of the applications include, but are not limited to, acid mine neutralization of contaminated fluid generated during the metal mining process, industrial and chemical neutralization of acid baths used in the steel coating process, mixing and blending of medicine in the pharmaceutical industry, mixing and blending used for pigments and dyes, and mixing and blending used in agricultural chemicals.

In accordance with another embodiment of the present invention, the fluidizing reactor 10 may be modified for use as a filtration unit. Referring again to FIG. 2A, fluid to be treated may be introduced through outlet 123 into the upper portion 133 of the interior chamber 13. When additional fluid is introduced into the interior chamber 13, the fluid within the interior chamber 13 is pushed downward into the bed of granular material 134. As the fluid travels through the bed of granular material 134 toward the bottom portion 135, the bed of granular material 134 gets compacted and acts as a filter to trap and remove particulates within the fluid. The fluid exiting the bed of granular material 134 may thereafter be directed through the annulus 19 and into the plenum 16 and removed through the inlet 165. Configuration of the reactor 10 as a filtration unit may prove useful for different applications carried out in industries where liquid filtration may be required.

While the invention has been described in connection with the specific embodiments thereof, it will be understood that it is capable of further modification. Furthermore, this application is intended to cover any variations, uses, or adaptations of the invention, including such departures from the present disclosure as come within known or customary practice in the art to which the invention pertains, and as fall within the scope of the appended claims.

1. A method for treating a fluid, the method comprising:
A) providing a reactor that includes:
i) an inlet;
ii) a column having an interior, an upper end, a lower end, and a lower interior surface at the lower end;
iii) an outlet situated near the upper end of the column;
iv) a bed of granular treatment material situated at the lower end of the column and resting upon the lower interior surface of the column;
v) a plenum in communication with the inlet and situated circumferentially about the lower end of the column and having a lower end; and
vi) an annular opening providing fluid communication between the plenum and the interior of the column, the annular opening being situated between the lower end of the plenum and the lower interior surface of the column; and
B) so introducing a fluid to be treated into the inlet that the fluid flows downward through the plenum, through the annular opening, directly from the annular opening to the bed of granular treatment material, and upward through the bed of granular treatment material so that the fluid fluidizes the bed of granular treatment material and exits the reactor through the outlet.

2. A method for treating a fluid, the method comprising:
A) providing a reactor that includes:
i) an inlet;
ii) a column having an interior, an upper end, a lower end, and a lower interior surface at the lower end;
iii) an outlet situated near the upper end of the column;
iv) a bed of granular treatment material situated at the lower end of the column and resting upon the lower interior surface of the column;
v) a plenum in communication with the inlet and situated circumferentially about the lower end of the column and having a lower end; and
vi) an annular opening providing fluid communication between the plenum and the interior of the column, the annular opening being situated between the lower end of the plenum and the lower interior surface of the column; and
B) so introducing a fluid to be treated into the inlet that the fluid flows downward through the plenum in a cyclonic flow pattern through the annular opening, directly from the annular opening to the bed of granular treatment material, and upward through the bed of granular treatment material so that the fluid fluidizes the bed of granular treatment material and exits the reactor through the outlet.

3. A method for treating a fluid, the method comprising:
A) providing a reactor that includes:
i) an inlet;
ii) a column having an interior, an upper end, a lower end, and a lower interior surface at the lower end;
iii) an outlet situated near the upper end of the column;
iv) a bed of granular treatment material situated at the lower end of the column and resting upon the lower interior surface of the column;
v) a plenum in communication with the inlet and situated circumferentially about the lower end of the column and having a lower end; and
vi) an annular opening providing fluid communication between the plenum and the interior of the column, the annular opening being situated between the lower end of the plenum and the lower interior surface of the column; and
B) so introducing a fluid to be treated into the inlet that the fluid flows downward through the plenum, through the annular opening, directly from the annular opening to the bed of granular material, and upward through the bed of granular treatment material so that the fluid fluidizes the bed of granular treatment material and exits the reactor through the outlet, wherein the fluid flow through the inlet is substantially equal to the fluid flow through the outlet.

4. The method for treating a fluid of claim 3, wherein the reactor further comprises a deflector so shaped and positioned so that it guides fluid flow from the annulus upward toward a center of the column.

5. A method for treating a fluid, the method comprising:
A) providing a reactor that includes:
i) an inlet;
ii) a column having an interior, an upper end, a lower end, and a lower interior surface at the lower end;
iii) an outlet situated near the upper end of the column;
iv) a bed of granular treatment material situated at the lower end of the column and resting upon the lower interior surface of the column;
v) a plenum in communication with the inlet and situated circumferentially about the lower end of the column and having a lower end; and
B) introducing a fluid to be treated into the inlet, so that the fluid flows downward through the plenum with a flow velocity having a vertical component, through a region in which the vertical component of the flow velocity reverses direction, directly into the bed of granular treatment material, and upward through the bed of granular treatment material so that the fluid fluidizes the bed of granular treatment material and exits the reactor through the outlet; wherein the fluid flow through the inlet is substantially equal to the fluid flow through the outlet.

6. The method for treating a fluid of claim 5, wherein the reactor further comprises a deflector so shaped and positioned that it guides fluid flow from the region in which the vertical component of the flow velocity reverses direction upward toward a center of the column.

7. A method for treating a fluid, the method comprising:
A) providing a reactor that includes:
i) an inlet;
ii) a column having an interior, an upper end, a lower end, and a lower interior surface at the lower end;
iii) an outlet situated near the upper end of the column;
iv) a bed of granular treatment material situated at the lower end of the column and resting upon the lower interior surface of the column;
v) a plenum in communication with the inlet and situated circumferentially about the lower end of the column and having a lower end; and
B) introducing a fluid to be treated into the inlet, so that the fluid flows downward through the plenum with a flow velocity having a vertical component, through a region in which the vertical component of the flow velocity reverses direction, directly into the bed of granular treatment material, and upward through the bed of granular treatment material so that the fluid fluidizes the bed of granular treatment material and exits the reactor through the outlet; wherein the fluid flow upward from the region in which the vertical component of the flow velocity reverses direction is substantially equal to the fluid flow through the outlet.

8. The method for treating a fluid of claim 7, wherein the reactor further 2 comprises a deflector so shaped and positioned that it guides fluid flow from the region in which the vertical component of the flow velocity reverses direction upward toward a center of the column.

9. A method for treating a fluid, the method comprising:
A) providing a reactor that includes:
i) an inlet;
ii) a column having an interior, an upper end, a lower end, and a lower interior surface at the lower end;
iii) an outlet situated near the upper end of the column;
iv) a bed of granular treatment material situated at the lower end of the column and resting upon the lower interior surface of the column;
v) a plenum in communication with the inlet and situated circumferentially about the lower end of the column and having a lower end; and
vi) an annular opening providing fluid communication between the plenum and the interior of the column, the annular opening being situated between the lower end of the plenum and the lower interior surface of the column; and
B) so introducing a fluid to be treated into the inlet that the fluid flows downward through the plenum in a substantially cyclonic flow pattern with a flow velocity having a substantially uniform vertical component, through the annular opening, directly from the annular opening to the bed of granular treatment material, and upward through the bed of granular treatment material so that the fluid fluidizes the bed of granular treatment material and exits the reactor through the outlet; wherein the fluid flow through the inlet is substantially equal to the fluid flow through the outlet.

10. The method for treating a fluid of claim 9, wherein the reactor further comprises a deflector so shaped and positioned that it guides fluid flow from the region in which the vertical component of the flow velocity reverses direction upward toward a center of the column.

11. The method for treating a fluid of claim 9, wherein the fluid flowing upward through the bed of granular treatment material flows in a substantially cyclonic flow pattern.

12. The method for treating a fluid of claim 11, wherein the reactor further comprises a deflector so shaped and positioned that it guides fluid flow from the region in which the vertical component of the flow velocity reverses direction upward toward a center of the column.

13. A method for treating a fluid, the method comprising:
A) providing a reactor that includes:
i) an inlet;
ii) a column having an interior, an upper end, a lower end, and a lower interior surface at the lower end;
iii) an outlet situated near the upper end of the column;
iv) a bed of granular treatment material situated at the lower end of the column and resting upon the lower interior surface of the column;
v) a plenum in communication with the inlet and situated circumferentially about the lower end of the column and having a lower end; and
B) introducing a fluid to be treated into the inlet, so that the fluid flows downward through the plenum in a substantially cyclonic flow pattern with a flow velocity having a vertical component, through a region in which the vertical component of the flow velocity reverses direction, directly into the bed of granular treatment material, and upward through the bed of granular treatment material so that the fluid fluidizes the bed of granular treatment material and exits the reactor through the outlet; wherein the fluid flow through the inlet is substantially equal to the fluid flow through the outlet.

14. The method for treating a fluid of claim 13, wherein the reactor further comprises a deflector so shaped and positioned that it guides fluid flow from the region in which the vertical component of the flow velocity reverses direction upward toward a center of the column.

15. The method for treating a fluid of claim 13, wherein the fluid flowing upward through the bed of granular treatment material flows in a substantially cyclonic flow pattern.

16. The method for treating a fluid of claim 15, wherein the reactor further comprises a deflector so shaped and positioned that it guides fluid flow from the region in which the vertical component of the flow velocity reverses direction upward toward a center of the column.

17. A method for treating a fluid, the method comprising:
A) providing a reactor that includes:
i) an inlet;
ii) a column having an interior, an upper end, a lower end, and a lower interior surface at the lower end;
iii) an outlet situated near the upper end of the column;
iv) a bed of granular treatment material situated at the lower end of the column and resting upon the lower interior surface of the column;
v) a plenum in communication with the inlet and situated circumferentially about the lower end of the column and having a lower end; and
B) introducing a fluid to be treated into the inlet, so that the fluid flows downward through the plenum in a substantially cyclonic flow pattern with a flow velocity having a vertical component, through a region in which the vertical component of the flow velocity reverses direction, directly into the bed of granular treatment material, and upward through the bed of granular treatment material so that the fluid fluidizes the bed of granular treatment material and exits the reactor through the outlet; wherein the fluid flow upward from the region in which the vertical component of the flow velocity reverses direction is substantially equal to the fluid flow through the outlet.

18. The method for treating a fluid of claim 17, wherein the reactor further comprises a deflector so shaped and positioned that it guides fluid flow from the region in which the vertical component of the flow velocity reverses direction upward toward a center of the column.

19. The method for treating a fluid of claim 17, wherein the fluid flowing upward through the bed of granular treatment material flows in a substantially cyclonic flow pattern.

20. The method for treating a fluid of claim 19, wherein the reactor further comprises a deflector so shaped and positioned that it guides fluid flow from the region in which the vertical component of the flow velocity reverses direction upward toward a center of the column.

21. A method for treating a fluid, the method comprising:
A) providing a reactor that includes:
i) an inlet;
ii) a column having an interior, an upper end, a lower end, and a lower interior surface at the lower end, the lower interior surface having a lowest point;
iii) an outlet situated near the upper end of the column;
iv) a bed of granular treatment material situated at the lower end of the column and resting upon the lower interior surface of the column;
v) a plenum in communication with the inlet and situated circumferentially about the lower end of the column and having a lower end; and
B) introducing a fluid to be treated into the inlet, so that the fluid flows downward through the plenum with a flow velocity having a vertical component, through a reversal region in which the vertical component of the flow velocity reverses direction, into the bed of granular treatment material, and upward through the bed of granular treatment material so that the fluid fluidizes the bed of granular treatment material and exits the reactor through the outlet; wherein the fluid flow through the inlet is substantially equal to the fluid flow through the outlet, and wherein the fluid flow through the reversal region reaches a lowest point of the flow, the lowest point of the flow being higher than the lowest point of the lower interior surface upon which the bed of granular treatment material rests.
